(19) United States
(12) Patent Application Publication
(10) Pub. No.: US 2025/0189059 A1
(43) Pub. Date: Jun. 12, 2025

(54) DEFORMABLE VALVE SPACER RING SYSTEM AND METHOD

(71) Applicant: Baker Hughes Oilfield Operations LLC, Houston, TX (US)

(72) Inventors: Fabio Tanaka, Houston, TX (US); Javier Garcia, Houston, TX (US); Lloyd Cheatham, Lake Jackson, TX (US); Xichang Zhang, Houston, TX (US)

(73) Assignee: Baker Hughes Oilfield Operations LLC, Houston, TX (US)

(21) Appl. No.: 18/530,372

(22) Filed: Dec. 6, 2023

(51) Int. Cl. F16K 41/04; F16K 3/02

(52) U.S. Cl. CPC F16K 41/043; F16K 3/0254

(57) ABSTRACT

A valve assembly includes a valve body having a stem bore extending along a stem bore axis and a flow bore extending along a valve body axis, a bonnet coupled to the valve body via one or more fasteners, a stem extending along the stem bore axis and within the stem bore, a packing system positioned along the stem within an annulus formed between the stem and the bonnet, a spacer ring positioned axially above the packing system, and a packing gland coupled to the bonnet to axially secure at least the packing system within the annulus. The spacer ring is positioned in a non-loaded configuration within the annulus such that one or both of an outer diameter or an inner diameter of the spacer ring is separated from one or both of the stem or the bonnet via a respective gap.

### BACKGROUND

### 1. Field of Disclosure

Embodiments of the present disclosure relate to valve systems, and in particular, to components that may be used with various valve configurations, such as fire safe valves.

### 2. Description of Related Art

Valves are used in a variety of industries to regulate fluid flow. In certain industries, such as oil and gas drilling and recovery, fire safe valves may be used to ensure hazardous or flammable fluid from piping systems does not leak from the valves after exposure to fire or high temperatures. What makes a valve “fire safe” may be determined by a relevant Fire Test Specification for a particular type of valve and/or a particular industry. As various industrial applications progress, different specifications may be announced, and as a result, once qualifying valves may no longer be deemed “fire safe” and it may be desirable to modify existing valves to meet evolving standards and/or design new valve configurations using the updated standards.

### SUMMARY

Applicant recognized the problems noted above herein and conceived and developed embodiments of systems and methods, according to the present disclosure, for valve systems.

In an embodiment, a valve assembly includes a valve body having a stem bore extending along a stem bore axis and a flow bore extending along a valve body axis, the stem bore axis and the flow bore being substantially perpendicular, a bonnet coupled to the valve body via one or more fasteners, a stem extending along the stem bore axis and within the stem bore, a valve drive train coupled to the stem and configured to drive movement of the stem between a first position and a second position, a packing system positioned along the stem within an annulus formed between the stem and the bonnet, a spacer ring positioned axially above the packing system, and a packing gland coupled to the bonnet to axially secure at least the packing system within the annulus. The spacer ring is positioned in a non-loaded configuration within the annulus such that one or both of an outer diameter or an inner diameter of the spacer ring is separated from one or both of the stem or the bonnet via a respective gap.

In an embodiment, a valve assembly includes a valve stem, a bonnet having a bore to receive the valve stem, a packing system positioned radially between the valve stem and the bonnet, and a spacer ring arranged axially above the packing system in an unloaded configuration, the spacer ring have an axial thickness configured to deform responsive to a exposure to a threshold pressure after failure of the packing system.

In an embodiment, a valve assembly includes a valve body having a stem bore extending along a stem bore axis and a flow bore extending along a valve body axis, the stem bore axis and the flow bore being substantially perpendicular. The valve assembly also includes a bonnet coupled to the valve body via one or more fasteners. The valve assembly further includes a stem extending along the stem bore axis and within the stem bore. The valve assembly also includes a valve drive train coupled to the stem and configured to drive movement of the stem between a first position and a second position. The valve assembly includes a packing system positioned along the stem within an annulus formed between the stem and the bonnet. The valve assembly further includes a spacer ring positioned axially above the packing system. The valve assembly also includes a packing gland coupled to the bonnet to axially secure at least the packing system within the annulus. The spacer ring is positioned in a non-loaded configuration within the annulus such that one or both of an outer diameter or an inner diameter of the spacer ring is separated from one or both of the stem or the bonnet via respective gaps

In an embodiment a valve assembly includes a valve stem, a bonnet having a bore to receive the valve stem, a packing system positioned radially between the valve stem and the bonnet, and a spacer ring arranged axially above the packing system in an unloaded configuration, the spacer ring have a radial thickness formed by an inner diameter and an outer diameter configured to deform responsive to exposure to a threshold pressure after failure of the packing system.

In an embodiment, method includes receiving a valve having an annulus between a stem and a bonnet. The method also includes positioning a packing system within the annulus. The method further includes positioning a spacer ring within the annulus, axially above the packing system. The method also includes securing the packing system within the annulus using a packing gland. The method further includes causing the packing system to be exposed to a degrading operating condition. The method includes causing, after the packing system is exposed to the degrading operating condition, continued operation of the valve such that a pressure deforms the spacer ring.

### BRIEF DESCRIPTION OF DRAWINGS

The present technology will be better understood on reading the following detailed description of non-limiting embodiments thereof, and on examining the accompanying drawings, in which:

FIG. 1 is a schematic cross-sectional view of an embodiment of a valve assembly, in accordance with embodiments of the present disclosure;

FIG. 2 is a schematic cross-sectional view of the embodiment of a valve assembly, in accordance with embodiments of the present disclosure;

FIG. 3A is a schematic cross-sectional view of an embodiment of a spacer ring associated with a valve assembly, in accordance with embodiments of the present disclosure;

FIG. 3B is a schematic cross-sectional view of an embodiment of a spacer ring associated with a valve assembly, in accordance with embodiments of the present disclosure;

FIG. 3C is a top plan view of an embodiment of a spacer ring, in accordance with embodiments of the present disclosure;

FIG. 3D is a cross-sectional view of an embodiment of a spacer ring, in accordance with embodiments of the present disclosure;

FIG. 3E is a cross-sectional view of an embodiment of a spacer ring taken along 3E-3E, in accordance with embodiments of the present disclosure;

FIG. 4 is a schematic cross-sectional view of an embodiment of a spacer ring associated with a valve assembly, in accordance with embodiments of the present disclosure; and

FIG. 5 is a flow chart of a method for installing and using a spacer ring with a valve assembly, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Like numbers may be used to refer to like elements throughout, but it should be appreciated that using like numbers is for convenience and clarity and not intended to limit embodiments of the present disclosure. Moreover, references to “substantially” or “approximately” or “about” may refer to differences within ranges of +/−10 percent.

Embodiments of the present disclosure are directed toward valve configurations that may achieve a “first safe” designation, such as by complying with one or more industry specifications associated with a particular designation. By way of non-limiting example, the API 6FA Fire Test Specification for Valves may be one such specification to provide this designation, but it should be appreciated that various others may also be used in a variety of different industries. Systems and methods of the present disclosure may incorporate one or more features within a valve configuration in order to satisfy various industry specifications, which may include API 6FA, by incorporating a deformable spacer ring into a valve assembly. The deformable spacer ring may be installed within a cavity (e.g., an annulus formed in a valve body and/or a bonnet) such that the deformable spacer ring is arranged radially between a valve stem and one or more portions of a valve body and/or a bonnet. In operation, the deformable spacer ring may be configured such that contact is avoided and/or minimized between one or both of the valve stem and the valve body and/or the bonnet, but after exposure to pressure, the deformable spacer ring may deform to contact one or more of the valve stem and/or the valve body and/or the bonnet to restrict flow through the cavity. In at least one embodiment, the deformable spacer ring may not form a full seal within the cavity (e.g., the sealing configuration of the deformable spacer ring may not be a “rated” seal), but rather, will restrict flow to below a predetermined amount associated with one or more industry standards, thereby permitting certification of the associated valve as a fire safe valve or other designation.

Previously, certain fire safe valves were developed aiming to validate valves per one or more specifications, such as the API 6FC Fire Test Specification for Valves with Automatic Backseats. Per API 6FC, a stuffing box (e.g., stem packing) could be replaced after the fire test, prior to submitting the valve to open under differential pressure and being tested for external leakage. However, standards and specifications often change within industries, such as oil and gas exploration and production, and API 6FC was withdrawn and replaced. One replacement standard, as a non-limiting example, that may now be used to designate a valve as being fire safe is API 6FA Fire Test Specification for Valves, which does not allow the replacement of the stuffing box prior to submitting the valve to open under differential pressure and testing for leakage. In an attempt to comply with this new standard, various manufacturers have used elaborated drive trains for the manual valves and other alternative designs, which have had varying degrees of success, but have significantly increased costs and complexity for valves.

As one non-limiting example, fire safe valves validated per API 6FA are submitted to a flame with a temperature range of 1400° F. to 1800° F. for at least 30 minutes, while in the closed position and pressurized. During this process, seat and external leakages are monitored, with a maximum leak acceptance criterion. After 30 minutes of being subjected to a flame, the valve temperature is decreased to 212° F. or less within 30 minutes, while leakage is also monitored. After cool down, pressure is applied on the upstream side of the valve and it must open under high differential pressure until its half open position, while external leakage is monitored for 5 minutes, with a maximum acceptable leak rate.

Most non-rising stem valves used in oil and gas operations use elastomeric or plastomeric/thermoplastic stem seals that provide both static and dynamic sealing conditions while the valve is operated, usually by rotating the stem and/or threaded system against a drive nut located within the obturator of the valve. These valves usually have an integral shoulder (backseat) on the stem that stops on the backseat of the bonnet, allowing a metal-to-metal seal interface in case of an accident. However, while submitted to the high temperature from the flame during the fire test, the elastomeric or plastomeric/thermoplastic material of the stem seal deteriorates, causing the valve to lose its sealing capacity along the stem. Some valve models have a disk made of eutectic material that melts at high temperature (e.g., at a specified temperature that may be less than surrounding materials associated with the valve), in a location that allows the stem to move to the backseat closed position, assisted by the pressure in the valve cavity and/or a spring force. This allows the valve to be approved on the external leakage criteria during and after the fire test. However, for valves that need to disengage the backseat to allow rotating the stem to open the valves after the fire test, a metal seal (or similar material resistant to high temperature) needs to be activated to control the external leakage through the stem/packing gland/bonnet system.

Embodiments of the present disclosure provide systems and methods for complying with one or more testing standards to certify a valve as being “first safe,” such as, but not limited to, API 6FA. As noted herein, after cool down from the burning process established by the specification, pressure is applied on the upstream side of the valve, which needs to be open under high differential pressure until in its half open position, while external leakage is monitored for 5 minutes, with a limited acceptable leak rate. Various embodiments described herein utilize a deformable metal spacer ring that is activated after the primary stem and sealing system is deteriorated after the equipment is subject to the first testing temperatures, which are typically around 1300° F., but may be greater than or less than 1300° F. (e.g., up to approximately 1800° F.). In at least one embodiment, the deformable metal spacer ring is placed downstream of the pressure source (e.g., the valve cavity) and protected by a primary stem sealing system (e.g., stem sealing system) which may include one or more thermoplastic materials, among other options. The spacer ring may be installed such that it is not pre-loaded, which may avoid scratches on the stem sealing surface during normal operational conditions, and is positioned in an annular space between the stem and the bonnet and/or valve body such that the spacer ring is permitted axial movement to an extent limited by a packing gland. Once the valve is subject to higher temperatures due to the fire testing procedure, the primary stem sealing system may deteriorate to an extent that the deformable metal spacer ring is subject to a pressure load (e.g., from the valve cavity) that is sufficient to deform the spacer ring (e.g., radial deformation), leading to a sealing effect between the bonnet and/or valve body, packing gland, and the valve stem (e.g., between the bonnet and the packing gland and between the stem and the packing gland). As described herein, formation may include deforming one or more legs to expand radially outward from a body centerline of the spacer ring and/or to expand a portion of a body of the spacer ring, among various other options based on spacer ring configurations.

Embodiments of the present disclosure address problems with existing valve configurations. For example, most metal seals that are not pre-loaded during the assembly process are energized through a mechanical feature, like a piston or cylinder system, pushing the ring sealing surfaces against the inner diameter and outer diameter of the matting components and their respective sealing areas. The spacer ring of the present disclosure is not pre-loaded (e.g., not pre-energized). In contrast, when a primary sealing system is compromised, pressure from the valve cavity acts on the deformable spacer ring to load the spacer ring against the matting components. Some seals that could have some low pre-load are usually made of soft materials, such as thermoplastic and/or elastomeric materials, and are then pressurized against the matting surfaces. Such configurations will not work with the fire safe valves because these materials cannot survive the testing (e.g., high temperatures) associated with certain processes, such as API 6FA. In contrast, embodiments of the present disclosure provide a metallic spacer ring formed from a particularly selected material to withstand the high temperatures during the fire testing and that may be pressure energized after the primary sealing system is compromised. During normal operation, the spacer ring of the present disclosure is not pre-loaded, which avoids damage to the stem sealing surface. Accordingly, systems and methods address problems with existing configurations by providing a spacer ring that does not need to be pre-loaded during assembly or normal operation, avoiding contact with and subsequent scratches to a dynamic stem sealing surface. After testing, such as fire testing per API 6FA, the primary stem sealing system is damaged and pressure from the valve cavity pushes the spacer ring against the packing gland, deforming the spacer ring (e.g., legs of the spacer ring, a body of the spacer ring, etc.) against the stem/packing gland and packing gland/bonnet clearances, providing enough sealing capacity to keep the external leakage within acceptance criteria for testing requirements, such as API 6FA. Embodiments also address problems with existing configurations in which metal seals are manufactured with requirements of minimum pre-loads and specific groove sizing to guarantee sufficient sealing capacity. Systems and methods do not require such long-term usage or full sealing, so self-adjusting to small clearances between the compromising parts may be provided without the specific manufacturing processes of existing systems. Additionally, the deformable seals of the present disclosure may be manufactured with looser tolerances, thereby permitting incorporation into existing systems for retrofitting applications.

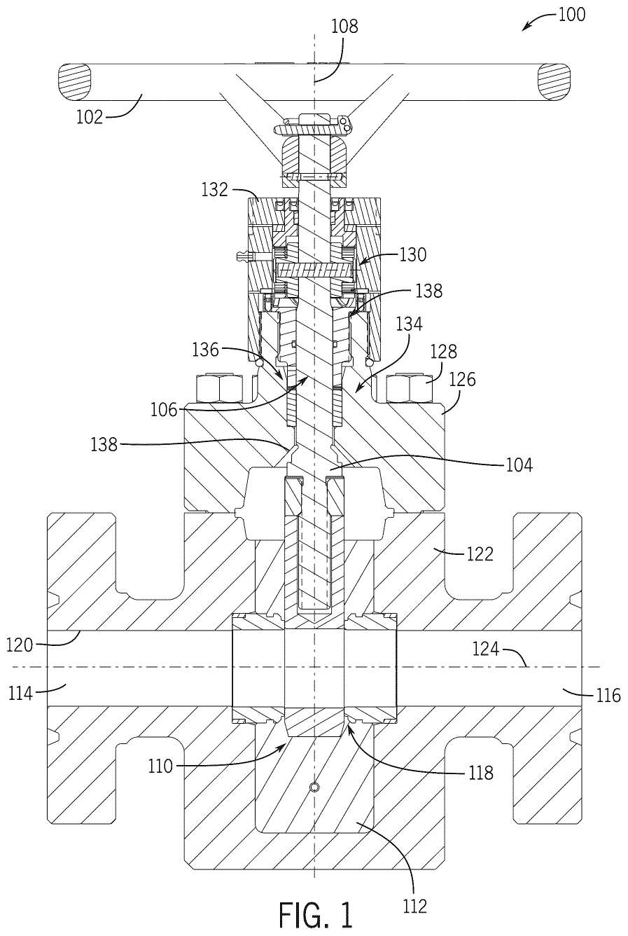

FIG. 1 is a cross-sectional side view of an embodiment of a valve assembly 100. Various components have been removed for simplicity with the present discussion, but additional components may be used with the valve assembly 100. Furthermore, while the illustrated valve assembly 100 is directed toward a gate valve, systems and methods may be used with a variety of other valve types. The illustrated valve assembly 100 includes an actuator 102. It should be appreciated that while the illustrated actuator 102 is a manual hand wheel, that automated or controlled actuators may also be utilized within the scope of the present disclosure. The illustrated actuator 102 is coupled to a valve stem 104, that extends through a stem bore 106 along a stem bore axis 108. In some embodiments, the stem bore axis 108 is aligned with a valve stem axis. In this embodiment, the valve stem 104 similarly extends through the stem bore 106 along the valve stem axis. The valve stem 104 is coupled to a valve member 110 arranged within a chamber 112. As shown, fluid (e.g., gas, liquid, solid, or a combination thereof) may enter the valve 100 through an inlet passage 114 and engage the valve member 110 en route to an outlet passage 116. The illustrated valve member 110 may seal against valve seats 118. In operation, a bore 120 extends through a valve body 122 along a valve body axis 124, which may also be referred to as a “cavity” where pressure is contained during operation, either by the valve body and/or by the valve body in combination with the valve member 110 when the valve member 110 is in a closed position (which is not shown in FIG. 1). The fluid is at a pressure and travels through the bore 120, for example, when the valve member 110 is positioned in an open position as shown in FIG. 1.

The illustrated valve assembly 100 also includes a bonnet 126 secured to the valve body 122 via one or more fasteners 128. While FIG. 1 is illustrated in cross-section, there may be several fasteners 128, which may vary in size. Surrounding the valve stem 104 and the stem bore 106 and aligned with the stem bore axis 108 of the valve assembly 100, is a drive train 130 (e.g., a valve drive train). The valve drive train 130 is contained within and aligned axially with a bonnet cap 132 along the stem bore axis 108. It should be appreciated that this configuration is for illustrative purposes only and that the bonnet cap 132 may be replaced with one or more other components.

As shown along at least a portion of the valve stem 104, a sealing system 134 (e.g., a primary stem sealing system, a stem sealing system, a primary sealing system, etc.) is formed to block ingress of fluid along the valve stem 104. The sealing system 134 is positioned between the valve stem 104 and the bonnet 126 in this configuration. The sealing system 134 may include an annular set of one or more seals, such as thermoplastic seals and/or elastomer seals, which are arranged in an annulus 136 formed within the bonnet 126 (e.g., at least a portion of the sealing system 134 may be seated on a shoulder of the bonnet 126 to block downward axial movement). A packing gland 138 (e.g., gland) may be secured to the bonnet 126 to axially restrict movement of the sealing system 134, and in certain embodiments, may compress one or more portions of the sealing system 134.

Embodiments of the present disclosure may incorporate one or more spacer rings (e.g., a deformable spacer ring, a deformable metal spacer ring, a ring, a spacer, etc.) along at least a portion of the valve stem 104 to block or restrict flow along the valve stem 104 and through the annulus 136 after one or more components of the sealing system 134 have degraded, such as after exposure to high temperatures during a fire test. In at least one embodiment, the one or more spacer rings are not positioned within the annulus 136 under a pre-load and may be said to “float” or otherwise permit movement of various other components, such as the valve stem 104, without contacting the valve stem 104 while the sealing system 134 is operational. However, upon degradation of the sealing system 134, a pressure from the cavity may enter the annulus 136 and deform the one or more spacer rings, such as deformation in radial directions (e.g., radially inward and/or radially outward relative to a spacer ring center line) to restrict or otherwise block flow through the annulus. The restriction or blockage may not be a full metal-to-metal seal with the surrounding components. In other words, the restriction may not be a full-pressure seal or a rated seal, but instead, may be used to restrict leakage to less than a desired or specified flow rate. In this manner, the inclusion of the one or more spacer rings may be used to certify one or more valve assemblies as being “fire safe.” Additionally, various embodiments may particularly select one or more components of the one or more spacer rings to be functional and/or compatible with one or more existing valve configurations, thereby permitting retrofitting applications.

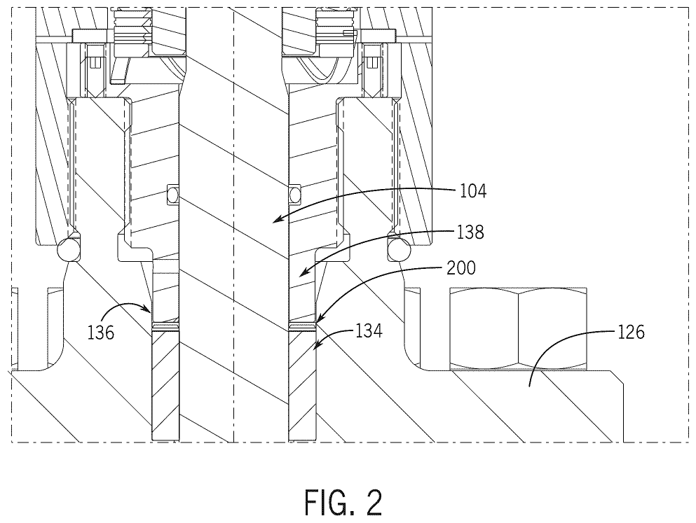

FIG. 2 is a detailed cross-sectional view of the valve assembly 100 in which a spacer ring 200 is installed within the annulus 136. In this example, the spacer ring 200 is positioned axially between the packing gland 138 and the sealing system 134. In other words, the spacer ring 200 is arranged between the packing gland 138 and the sealing system 134 such that the sealing system 134 blocks pressure from the cavity from interacting on either the spacer ring 200 or the packing gland 138 (when operational). The illustrated spacer ring 200 may be an annular ring that includes one or more inner diameters (e.g., radially closer to the valve stem 104) and one or more outer diameters (e.g., radially closer to the bonnet 126), as will be described herein. The configuration of FIG. 2 includes the spacer ring 200 in an installed position in which the packing gland 138 is secured to the bonnet 126, such as via one or more threads or various other fasteners. The spacer ring 200 is not under pre-load in this example, as will be shown in more detail herein, and may permit movement of the valve stem 104 without contact with the spacer ring 200 and/or with limited contact, thereby preventing scratching or marring of a sealing surface of the valve stem 104. Upon degradation of the sealing system 134, such as due to a fire test, pressure will enter the annulus 136, engage the spacer ring 200, and deform the spacer ring 200 such that the spacer ring 200 restricts flow through the annulus. For example, the spacer ring 200 may be deformed to contact one or more of the valve stem 104, the packing gland 138, and/or the bonnet 126.

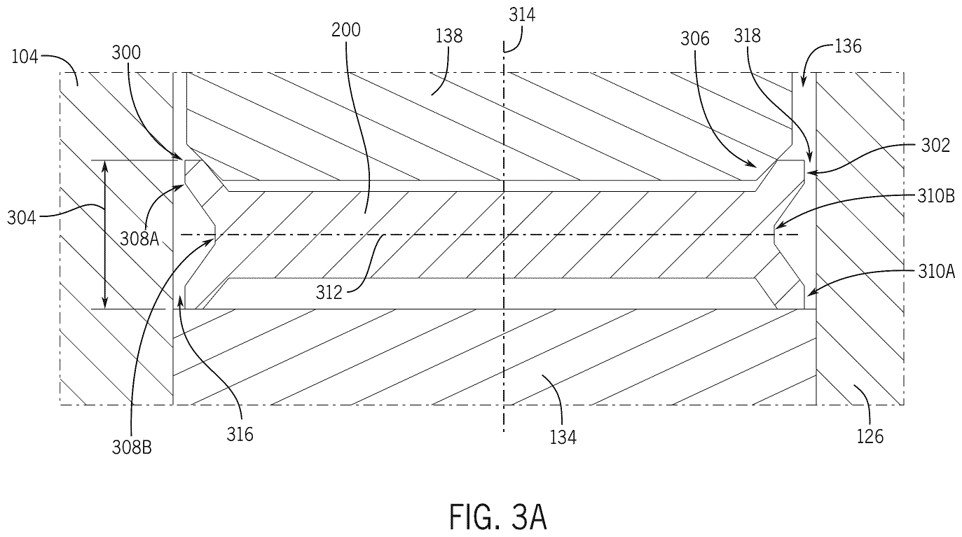

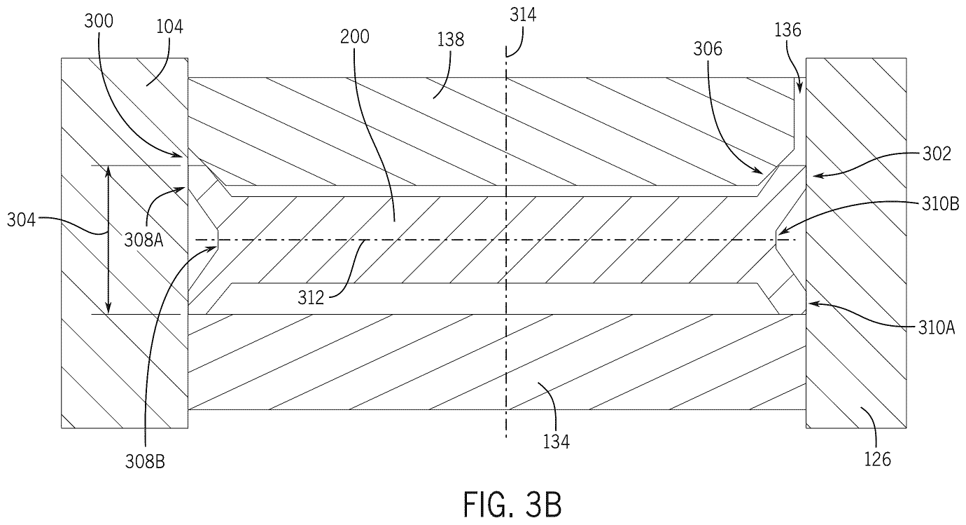

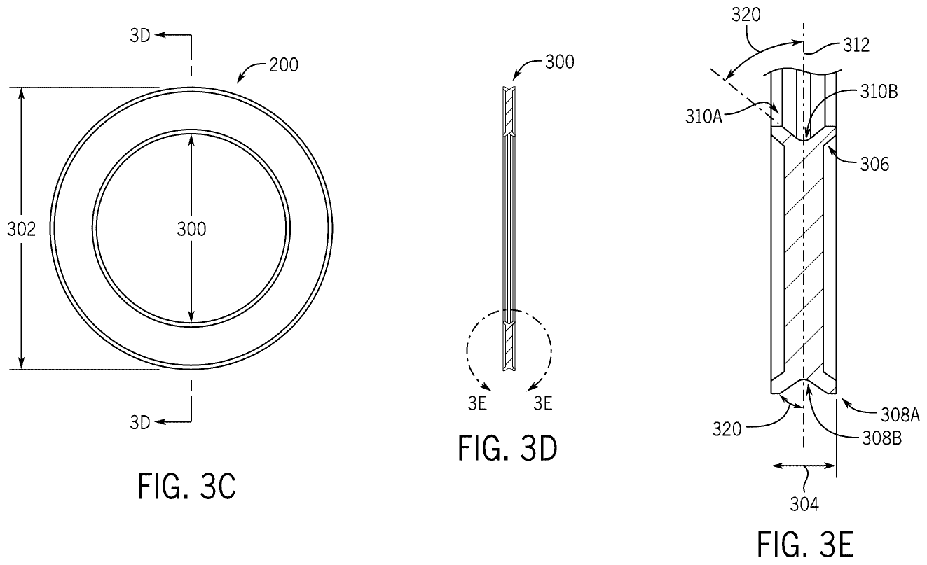

FIG. 3A illustrates a cross sectional view of the valve assembly 100 in which the spacer ring 200 is positioned within the annulus 136 axially between the packing gland 138 and the sealing assembly 134. In this configuration, the spacer ring 200 includes an inner diameter 300 and an outer diameter 302. While the configuration is shown as a cross-sectional view of only a portion of the spacer ring 200, it should be appreciated that the diameters discussed refer to an annular ring centered at the valve stem axis 108 (FIG. 1). The inner diameter 300 is shown as being radially closer to the valve stem 104 and the outer diameter 302 is shown as being radially closer to the bonnet 126. However, it should be appreciated that the inner diameter 300 may not be continuous or at a common position along an axial length 304 of the spacer ring 200. By way of non-limiting example, FIG. 3A illustrates pairs of legs 306 at both the inner diameter 300 and the outer diameter 302 such that each of the inner diameter 300 and the outer diameter 302 respectively include first and second diameters. That is, a first inner diameter 308A is closer to the valve stem 104 than a second inner diameter 308B and a first outer diameter 310A is closer to the bonnet 126 than a second outer diameter 310B. As in this example, the first inner diameter 308A is selected at a closest point to the valve stem 104 and the second inner diameter 308B is selected at a furthest point from the valve stem 104 along a profile of the inner diameter 300, but it should be appreciated that various other locations may be used to represent the first and second inner diameters 308A, 308B. Furthermore, there may be additional locations, such as a stepped profile to represent the inner diameter 300. Similarly, the illustrated first outer diameter 310A is selected at a closest point to the bonnet 126 and the second outer diameter 310B is selected at a furthest point from the bonnet 126 along a profile of the outer diameter 302, but it should be appreciated that various other locations may be used to represent the first and second outer diameters 310A, 310B. Furthermore, there may be additional locations, such as a stepped profile to represent the outer diameter 302. Accordingly, the configuration of the inner and outer diameters 300, 302 is provided by way of non-limiting example only and different components, such as the position of the legs 306, the inclusion of the legs 306, and the like may be adjusted based on operating conditions and/or design considerations, such as manufacturability, material selection, and the like.

Each of the illustrated legs 306 are positioned at an angle with respect to a horizontal center line 312 of the spacer ring 200. The illustrated horizontal center line 312 may be parallel to the valve body axis 124 (FIG. 1), but in other embodiments may be positioned at an angle depending on the configuration of the spacer ring 200. It should be appreciated that angles for the respective legs 306 may vary based on one or more design conditions. For example, the legs 306 at the inner diameter 300 may be at a different angle than the legs 306 of the outer diameter 302. In this example, the spacer ring 200 is shown as being symmetrical about the horizontal center line 312. Such a configuration is by way of non-limiting example. However, symmetry may simplify installation procedures because the orientation of the spacer ring 200 would not be a consideration when installing the spacer ring 200. For example, in certain embodiments the axial length 304 may be small, and as a result, it may be challenging to identify a “correct” orientation for installation, by providing a symmetrical spacer ring 200, the spacer ring 200 may be installed without considering the orientation. However, in embodiments where the space ring 200 is not symmetric about the horizontal center line 312, one or more markers or indications may be included, such as on a surface, to provide installation instructions.

As noted herein, various embodiments of the present disclosure incorporate the legs 306, which are arranged at respective inner and outer diameters 300, 302 of the spacer ring 200. In at least one embodiment, the spacer ring 200 may not be symmetric about a vertical center line 314. For example, the legs 306 may be arranged at different angles, extend different distances, have different thicknesses, and/or the like. In operation, when the spacer ring 200 is exposed to pressure from the cavity, such as due to degradation of the sealing system 134, the legs 306 may flex and/or deform radially away from the vertical center line 314. That is, the legs 306 associated with the inner diameter 300 may flex/deform toward the valve stem 104 and the legs 306 associated with the outer diameter 302 may flex/deform toward the bonnet 126. As a result, a flow path along the annulus 136 may be restricted and/or reduced, which will reduce leakage to below a threshold amount, thereby enabling verification according to one or more industry standards.

This example illustrates the spacer ring 200 being installed without a pre-load. That is, the spacer ring 200 is positioned such that it is not compressed or otherwise deformed at initial installation. Accordingly, an inner gap 316 and an outer gap 318 are shown between the inner diameter 300 and the valve stem 104 and the outer diameter 302 and the bonnet 126, respectively. In operation, pressure ingress into the annulus 136 will apply a force to the pressure ring 200 that causes the pressure ring 200 to deform, thereby driving the inner and outer diameters 300, 302 to engage their respective adjacent components to reduce and/or eliminate the gaps 316, 318. Furthermore, the pressure ring 200 may be driven to engage or otherwise compress against the packing gland 138. For example, the axially upper legs 306 may be driven against the packing gland 138, while also being driven against respective adjacent components (e.g., the valve stem 104 and/or the bonnet 126), thereby providing a flow restriction along the annulus 136. As noted herein, the flow restriction and/or seal may not be a pressure rated seal, but may be used to restrict or otherwise block flow at or below a desired leakage rate.

It should be appreciated that the configuration of the legs 306 shown in FIG. 3A is by way of non-limiting example and that different configurations, more or fewer legs, and the like may be incorporated. For example, the legs 306 may not be arranged at the same angle with respect to the legs at a given inner diameter 300 or outer diameter 302. Additionally, there may be more legs 306. Furthermore, the legs 306 may be different thicknesses to encourage more deformation at one location than other. Accordingly, various embodiments may particularly select different configurations, dimensions, and the like based on design and/or operating conditions.

FIG. 3B illustrates an example embodiment of the spacer ring 200 after the sealing system 134 has failed, thereby causing a pressure (e.g., a force) to enter the annulus 136 and act on the spacer ring 200, causing the spacer ring 200 to deform such that the inner diameter 300 and/or the outer diameter 302 restrict or otherwise block flow through the annulus 136. As noted, the restriction may not be a full pressure seal along the annulus 136, but may only reduce flow below a predetermined amount. However, in other embodiments, a seal or a substantial seal may be formed. In this example, both the gaps 316, 318 have been substantially eliminated due to the deformation of the spacer ring 200.

As noted herein, the deformation of the spacer ring 200 may take a variety of different forms, such as the legs 306 “flaring” radially outward from the vertical center line 314 to contact the respective adjacent components (e.g., the valve stem 104 and/or the bonnet 126). Additionally, deformation may also cause compression into the packing gland 138. In at least one embodiment, pressure entering the annulus 136 may not be sufficient to fully deform the spacer ring 200 to contact the adjacent components, but may at least reduce a size of the gaps 316, 318 (FIG. 3A) to restrict or otherwise reduce leakage, which may be sufficient for testing purposes to achieve the first safe rating per one or more specifications.

FIGS. 3C-3E illustrates a set of views for the spacer ring 200, including a top view (FIG. 3C), a cross-sectional view (FIG. 3D), and a cross-sectional view along line 3E-3E (FIG. 3E). As shown, the spacer ring 200 is an annular ring that includes the inner diameter 300 and the outer diameter 302. In this configuration, the inner diameter 300 may also include first and second inner diameters 308A, 308B due to the arrangement of the legs 306, and the outer diameter 302 may similarly include the first and second outer diameters 310A, 310B. The legs 306 are illustrated at respective angles 320 relative to the horizontal center line 312. As noted herein, the angles 320 may be any reasonable angle and may vary based on design conditions, such as space within the annulus 136, expected pressure of operations, material of construction for the spacer ring 200, and/or the like. In this example, the legs 306 associated with the outer diameter 302 are at different angles than the legs 306 associated with the inner diameter 300, but such a configuration is by way of example and the legs 306 may all be at common angles 320. Additionally, as noted herein, each individual leg 306 may be at a different angle 320, depending on desired design considerations.

As noted herein, the axial length 304 may be particularly selected based on one or more design considerations, such as material of construction, spacing for a given valve, operating conditions, and/or the like. Furthermore, thicknesses for the legs, leg lengths, and the like may similarly be adjusted based on various design conditions. Additionally, as noted herein, the spacer ring 200 may be formed from a variety of materials, such as stainless steels as one non-limiting example. Material properties may be considered when selecting materials, such as corrosion resistance, strength, manufacturability, and/or the like. Additionally, different conditioning operations may be applied to different materials to obtain one or more desired properties (e.g., cold working, heat treating, etc.). Accordingly, while stainless steel is referenced, various other materials may be selected so long as the materials have sufficient material properties, such as strength and heat resistance, to accommodate fire testing.

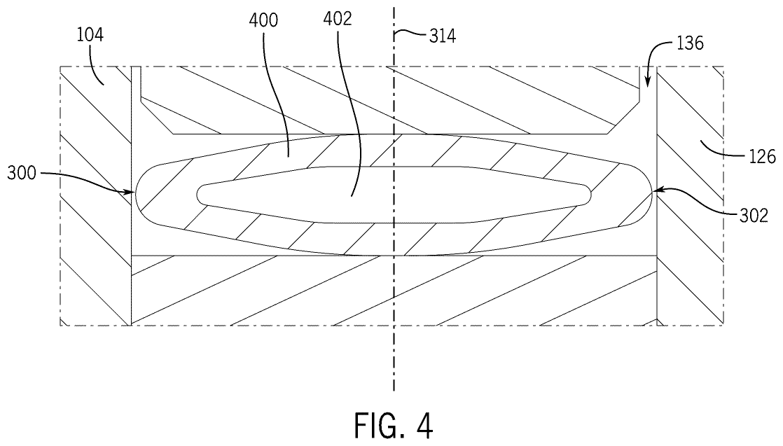

FIG. 4 illustrates an example embodiment of a spacer ring 400, which in this example does not include the legs 306, but still includes the inner diameter 300, the outer diameter 302, and various other components also shown with respect to the spacer ring 200 that will not be discussed here for conciseness. Much like the spacer ring 200, in operation, the spacer ring 400 will deform such that the inner diameter 300 expands away from the vertical center line 314 (e.g., the inner diameter 300 deforms toward the valve stem 104 and the outer diameter 302 deforms toward the bonnet 126) to restrict or block flow through the annulus 136. Furthermore, the spacer ring 200 may be compressed axially upward to drive portions of the spacer ring 200 into the packing gland 138.

The illustrated embodiment includes a hollow interior 402, which may be formed by one or more additive manufacturing processes, among other options. In this example, the interior 402 may include one or more relief holes or passages (not pictured) to prevent build up (e.g., fluid, pressure, etc.) within the interior 402. It should be appreciated that the interior 402 may also be vented in configurations where the spacer ring 400 is not fully connected along its outer surface, such as configurations where an end is folded into itself and/or doubled over.

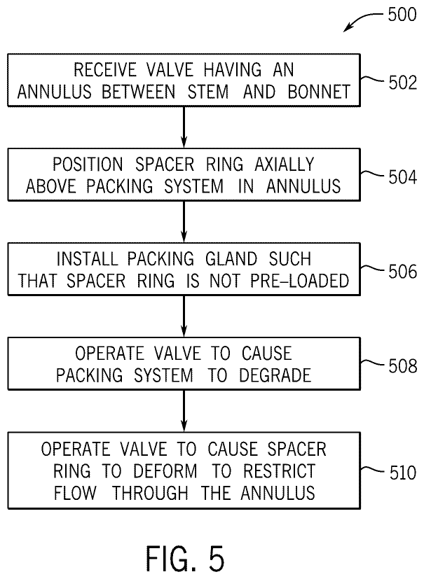

FIG. 5 is a flow chart of a method 500 for installing and operating a spacer ring. It should be appreciated that steps for the method may be performed in any order, or in parallel, unless otherwise specifically stated. Moreover, the method may include more or fewer steps. In this example, a valve is received that includes an annulus 502. The annulus may be between a valve stem and a valve body and/or bonnet. A spacer ring may be positioned within the annulus 504, such as axially above a packing system that is also within the annulus. A packing gland may then be installed 506 to secure the spacer ring and/or the packing system within the annulus. In at least one embodiment, the packing gland is installed such that the spacer ring is not pre-loaded. The valve may then be operated in a condition that causes the packing system to deteriorate 508, which may include operations during a fire test. The operation of the valve in such a condition may cause the spacer ring to deform, which may restrict flow through the annulus 510. In this manner, the spacer ring may be used to reduce leakage after a fire test.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A valve assembly, comprising:
a valve body having a stem bore extending along a stem bore axis and a flow bore extending along a valve body axis, the stem bore axis and the flow bore being substantially perpendicular;
a bonnet coupled to the valve body via one or more fasteners;
a stem extending along the stem bore axis and within the stem bore;
a valve drive train coupled to the stem and configured to drive movement of the stem between a first position and a second position;
a packing system positioned along the stem within an annulus formed between the stem and the bonnet;
a spacer ring positioned axially above the packing system; and
a packing gland coupled to the bonnet to axially secure at least the packing system within the annulus;
wherein the spacer ring is positioned in a non-loaded configuration within the annulus such that one or both of an outer diameter or an inner diameter of the spacer ring is separated from one or both of the stem or the bonnet via respective gaps.

2. The valve assembly of claim 1, wherein the spacer ring is configured to deform responsive to a pressure from the flow bore entering the annulus after degradation of the packing system.

3. The valve assembly of claim 1, wherein the spacer ring is configured to deform radially outward from a spacer ring vertical centerline toward the stem or toward the bonnet.

4. The valve assembly of claim 1, wherein the spacer ring includes legs at both an outer diameter and an inner diameter.

5. The valve assembly of claim 1, wherein the spacer ring is symmetrical about a horizontal center line.

6. The valve assembly of claim 1, wherein the spacer ring further comprises:
a first inner diameter;
a second inner diameter;
a first outer diameter; and
a second outer diameter;
wherein the first inner diameter is radially closer to the valve stem than the second inner diameter and the first outer diameter is radially closer to the bonnet than the second outer diameter.

7. The valve assembly of claim 1, wherein the spacer ring includes an open interior space.

8. The valve assembly of claim 7, wherein the space ringer includes one or more vents coupled to the open interior space.

9. The valve assembly of claim 1, wherein the spacer ring is formed from a metallic material.

10. The valve assembly of claim 9, wherein the spacer ring is configured to withstand a temperature above a threshold level that causes sealing degradation to the packing system.

11. A valve assembly, comprising:
a valve stem;
a bonnet having a bore to receive the valve stem;
a packing system positioned radially between the valve stem and the bonnet; and
a spacer ring arranged axially above the packing system in an unloaded configuration, the spacer ring have a radial thickness formed by an inner diameter and an outer diameter configured to deform responsive to exposure to a threshold pressure after failure of the packing system.

12. The valve assembly of claim 11, wherein the packing system is configured to fail responsive to high temperature operation associated with a fire test.

13. The valve assembly of claim 11, wherein the spacer ring has a hollow interior.

14. The valve assembly of claim 11, wherein the spacer ring is metallic.

15. The valve assembly of claim 11, wherein the spacer ring deforms to restrict passage along a flow path between the valve stem and the bonnet.

16. The valve assembly of claim 15, wherein the spacer ring deforms in a non-sealing configuration.

17. The valve assembly of claim 11, wherein the spacer ring includes a first pair of legs at the inner diameter and a second pair of legs at the outer diameter, each respective leg of the pairs of legs being arranged at an angle with respect to a horizontal center line of the spacer ring.

18. A method, comprising:
receiving a valve having an annulus between a stem and a bonnet;
positioning a packing system within the annulus;
positioning a spacer ring within the annulus, axially above the packing system;
securing the packing system within the annulus using a packing gland;
causing the packing system to be exposed to a degrading operating condition;
causing, after the packing system is exposed to the degrading operating condition, continued operation of the valve such that a pressure deforms the spacer ring.

19. The method of claim 18, wherein the packing gland does not apply a pre-load to the spacer ring.

20. The method of claim 18, wherein the degrading operating condition is exposure to temperatures above a threshold level.
